(19) United States
(12) Patent Application Publication
(10) Pub. No.: US 2009/0055411 A1
(43) Pub. Date: Feb. 26, 2009

(54) SYSTEM AND METHOD FOR PRECISELY HANDLING DURATION VALUES

(76) Inventors: Zhuo Meng, Broadview Heights, OH (US); Peter J. Herrera, San Jose, CA (US); Baofu Duan, Carmel, IN (US); Ronald J. Cass, Cleveland Heights, OH (US)

Correspondence Address: PILLSBURY WINTHROP SHAW PITTMAN, LLP, P.O. BOX 10500, MCLEAN, VA, 22102, US

(21) Appl. No.: 11/844,507

(22) Filed: Aug. 24, 2007

(51) Int. Cl. G06F 17/30

(52) U.S. Cl. 707/100; 707/E17.127

(57) ABSTRACT

A system and method for handling duration values includes associating a duration value with a start datetime to allow precise duration handling. Thus, a uniform time line approach may be used to handle duration arithmetic, comparisons, or other computations for duration values. For example, the uniform time line approach may characterize a duration value as a difference between two endpoints of a timeline segment having a length equal to the duration value. As a result, duration operations can be carried out with precision and accuracy using simple calendar calculations.

### FIELD OF THE INVENTION

The invention relates to precise handling of duration values in automated systems, and in particular, to precisely determining a duration of a time period between temporally separated events.

### BACKGROUND OF THE INVENTION

Many specifications, guidelines, recommendations, and other technologies have been standardized for use on the World Wide Web by an international standards organization known as the World Wide Web Consortium (W3C). For example, the W3C standards include an eXtensible Markup Language (XML) schema for defining a duration data type. The duration data type can be used to represent values for durations of time using a six dimensional coordinate value space (i.e., coordinates for designating Gregorian years, months, days, hours, minutes, and seconds). Using the XML schema definition, a duration of time can be represented lexically in an extended format of PnYnMnDTnHnMnS, where nY, nM, nD, T, nH, nM, and nS respectively represent a number of years, a number of months, a number of days, a date/time separator, a number of hours, a number of minutes, and a number of seconds.

For example, a duration value representing a duration of one year, two months, three days, ten hours, thirty minutes, and fifteen seconds would be lexically represented by P1Y2M3DT10H30M15S. In other instances, duration values may be represented in other ways, such as reduced precision representations, negative duration values, or truncated representations (e.g., values in a duration equaling zero may be omitted together with a corresponding designator, the T designator must be omitted when no time values exist, etc.). Additional information relating to the XML schema for duration values may be provided as described in “XML Schema Part 2: Datatypes Second Edition,” published Oct. 28, 2004, the contents of which are hereby incorporated by reference in their entirety.

However, XML duration value schema suffers from various drawbacks, which can undermine precision of operations handling values relating to durations, dates, and times, for example. Difficulties lie in a lack of precision due to variations in a number of days for a given month, and in a number of days for a given year, such that a duration value may not always accurately represent a length of time. For example, the standard duration value assumes a month of thirty days, such that the standard duration value would be non-deterministic for months having more or less than thirty days. As a result, a duration of one month, represented as P1M, could include anywhere from twenty-eight to thirty-one days. Similarly, the standard duration value assumes a year of three hundred and sixty-five days, which would be imprecise for durations including a leap year, which has three hundred and sixty-six days. Thus, existing techniques often provide imprecise representations of duration values, which can be unacceptable in automated systems that require accurate determinations of a period of time.

Existing systems suffer from these and other problems.

### SUMMARY OF THE INVENTION

According to various aspects of the invention, a system and method for handling duration values may address these and other drawbacks of existing systems. For example, a duration value may be associated with a start datetime to allow precise handling of a duration. Furthermore, a uniform time line approach may be used to handling duration arithmetic, comparisons, or other computations for duration values, with or without a start datetime. The uniform time line approach may characterize a duration value as a difference between two points on a time line, using a default start datetime as necessary. As a result, duration operations can be carried out with precision and accuracy using simple calendar calculations.

According to various aspects of the invention, precise handling of duration values may be provided for a duration expression that references a duration of time. The duration of time may have a temporal length that depends on one or more of a starting date or a starting time associated with the duration of time. The received duration expression may represent the duration of time according to one or more of a number of years, months, days, hours, minutes, or seconds. Further, the duration of time may be associated with a start datetime, which represents an endpoint of a timeline segment defined by the duration of time (e.g., the datetime on which the duration of time begins or ends). As a result, the temporal length of the duration of time can be precisely determined based on the start datetime associated with the duration of time, using the start datetime as a baseline for interpreting the duration of time.

Other objects and advantages of the invention will be apparent to those skilled in the art based on the following drawings and detailed description.

### BRIEF DESCRIPTION OF THE DRAWINGS

FIG. 1 illustrates a block diagram of an exemplary system for handling duration values according to various aspects of the invention.

FIGS. 2a-d illustrate various exemplary representations of duration values and associated operations according to various aspects of the invention.

### DETAILED DESCRIPTION

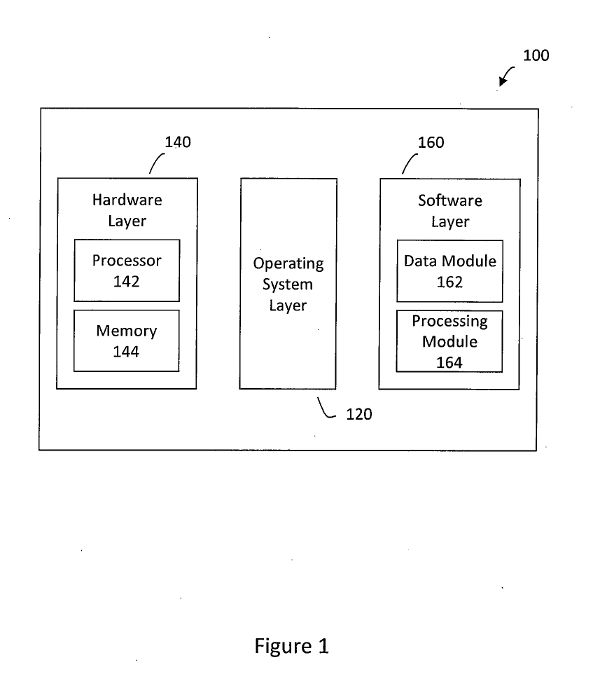

According to various aspects of the invention, FIG. 1 illustrates a block diagram of an exemplary system for handling duration values. The system may include a computing device 100, in which an operating system layer 120 provides an interface between a hardware layer 140 and a software layer 160. The software layer 160 may be implemented using any suitable programming language that can provide functionality in the computing device 100. As illustrated in FIG. 1, an exemplary implementation of the software layer 160 may include, among other things, a data module 162 and a processing module 164. The hardware layer 140 controls interaction with physical system resources, such as a processor 142 and a memory 144, among other physical hardware resources or devices, as will be apparent.

In a specific exemplary implementation of the invention, the data module 162 may utilize various data types for handling duration values. For example, in various implementations, the data types may be associated with a programming language that includes one or more definitions for a duration value, such as a duration data type defined for eXtensible Markup Language (XML). For example, XML includes a schema for duration, which represents a duration of time using a six dimensional value space. Coordinates of the value space designate Gregorian year, month, day, hour, minute, and second components, as standardized in §5.5.3.2 of ISO 8601, which relates to an international date format. Significance of the coordinates may be defined in accordance with an order appearance (i.e., year, month, day, hour, minute, and second).

Thus, using the XML schema, duration can be represented lexically in an extended format of PnYnMnDTnHnMnS, where nY, nM, nD, T, nH, nM, and nS represent a number of years, a number of months, a number of days, a date/time separator, a number of hours, a number of minutes, and a number of seconds, respectively. Furthermore, the number of seconds can include decimal digits to arbitrary precision. By way of example, two years, five months, fifteen days, seven hours, twenty minutes, and ten seconds would” be expressed as P2Y5M15DT7H20M10S (e.g., a duration value of negative ten days would be expressed as −P10D), and reduced precision and truncated expressions can be used in certain circumstances. For example, when the number of years, months, days, hours, minutes, or seconds in a value segment equals zero, the value and a corresponding designator can be omitted. However, at least one value and corresponding designator must be included. In another example, the T designator must be omitted when every time value segment equals zero, although the P designator must always be included.

Two or more durations may be related by a partial order, as certain durations may not necessarily have determinate relationships. For example, duration values of P1M and P30D would not necessarily be equivalent in every instance, as a number of days in a given month can vary between twenty-eight and thirty-one. Further, the number of days in February can vary from twenty-eight to twenty-nine, depending on leap years. As a result, all that can be said about a relationship between a duration of P1M and PnD may be that P1M>PnD for all n less than or equal to twenty-seven, and that P1M<PnD for all n greater than or equal to twenty-eight. By contrast, for values of n between twenty-eight and thirty-one, inclusive, the relationship will be indeterminate. The indeterminate range remains three for larger numbers of months, with an exception that twelve months multiples can be assumed as corresponding to years, in which case the indeterminate range may be one (i.e., either three hundred sixty-five or three hundred sixty-six, depending on leap years).

The XML schema, therefore, can only provide a determinate ordered relation between durations in certain circumstances. In particular, a total order can only be guaranteed when durations have fields limited to one of a set that includes {years, months} or {days, hours, minutes, seconds}. Further, when the durations have fields from the set that includes {days, hours, minutes, seconds}, precision can only be guaranteed by requiring or prohibiting a time zone definition for all durations being compared. For durations having fields from both sets, the order of the durations may potentially be indeterminate. One approach to eliminating such indeterminate orders includes assigning a constant equivalent value for varying terms. For example, indeterminate orders could be eliminated by making a false assumption that P1M=P30D. However, as P1Y=P12M, the false assumption results in P1Y being considered equivalent to P360D. Thus, using the duration values defined in the XML schema, indeterminacy can only be avoided by sacrificing accuracy.

By contrast, according to various aspects of the invention, duration values may be precisely handled by associating duration values with an attribute that represents a start datetime. Thus, when a duration has potentially indeterminate components (e.g., years or months), the duration can be precisely evaluated in combination with the start datetime attribute. For example, by associating a duration value contained in a duration expression with a start datetime attribute, various operations that handle values for durations, dates, and/or times may be precisely evaluated by providing a timeline by which to evaluate otherwise indeterminate components (e.g., for years, months, etc.). Although the data type may be defined using any suitable technique, as will be apparent, an exemplary generic form for the data type may represent a duration as:

dur:nynmndtnhnmns;yyyy-mm-ddthh:mm:ss±hh:mm

In the generic form provided, “dur:” may designate the duration data type, and “nynmndtnhnmns” may designate a duration in a similar manner as described above in the XML schema. Furthermore, the semicolon may be used to designate a separator between the duration and the start datetime, in which the start datetime may be represented by using “yyyy-mm-dd” to represent the start date, “t” to represent a start date/start time separator, “hh:mm:ss” to represent the start time, and “±hh:mm” to represent a time zone (e.g., were the time zone may be defined with respect to Greenwich Mean Time).

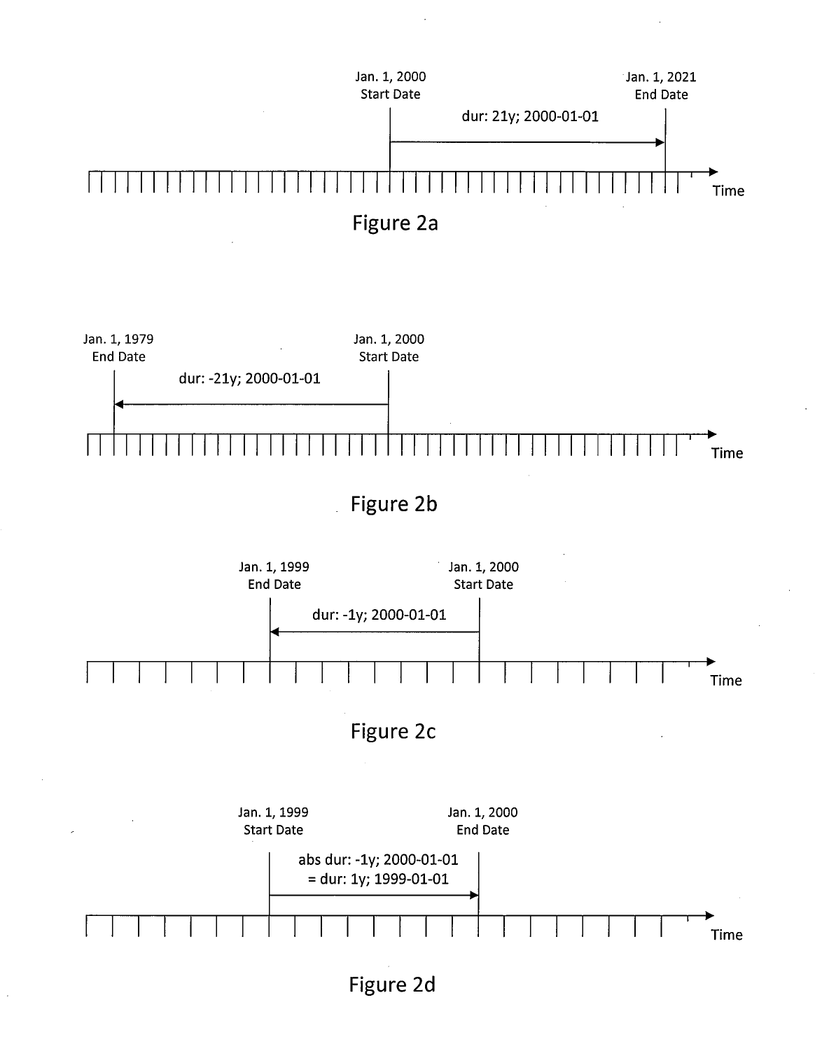

For example, as illustrated in FIG. 2a, the exemplary data type provided above may be used to express a duration of twenty-one years, which began at Jan. 1, 2000, as dur:21y;2000-01-01. In another example, a duration of one hundred years, one hundred months, one hundred days, one hundred hours, one hundred minutes, and one hundred seconds, which began at Feb. 20, 2002, at forty-three seconds past 1:15 p.m., Eastern Standard Time, may be expressed as dur:100y100 m100dt100h100 m100s;2002-02-20t13:15:53-05:00. Further, negative durations may be expressed with a “−” sign preceding a “dur” prefix. For example, as illustrated in FIG. 2b, a negative duration of twenty-one years, which ends at Jan. 1, 2000, may be expressed as dur:−21y;2000-01-01 (e.g., where the duration expression's start datetime represents the datetime at which the duration ends).

In various implementations of the invention, a start datetime may be expressed using a client-local time, where the start datetime may be assumed as being specified in Coordinated Universal Time (UTC) or Greenwich Mean Time (GMT), unless otherwise specified. Thus, the start datetime may be automatically transformed by converting the UTC/GMT start datetime into the client-local time (e.g., five hours may be subtracted from the start datetime for a client in an Eastern Standard Time zone). Alternatively, the start datetime may be assumed as being specified in the client-local time, or converted into UTC/GMT, or other variations may be used, as will be apparent. It will be appreciated that a party responsible for setting up a client system (e.g., computing device 100) should clearly indicate which approach will be taken towards transforming start datetimes, such that users, system administrators, or others will be aware of any implications of how a start datetime may be specified.

Thus, by associating a duration value with a start datetime, duration value orderings can be completely determinant, in that exact values of any imprecise units in the duration value can be easily determined using simple calendar operations. However, ordering a plurality of duration values may be based only on the duration value, as the start datetime will not necessarily be used for comparison purposes, but rather for interpreting the duration value. For example, dur:1y;2001-01-01 would be equivalent to dur:1y;2002-01-01 (i.e., as each duration includes three hundred and sixty-five days), but dur:1y;2001-01-01 would be one day less than dur:1y;2000-01-01 (i.e., because the year 2000 was a leap year that included three hundred and sixty-six days).

Additionally, in various implementations, a duration value expressed using the data type described above may omit the start datetime component, which would leave the start datetime undefined. For durations having an undefined start datetime, ordering of two or more durations may be subject to similar problems of indeterminacy, as discussed above in connection with the duration value defined in the XML schema. Thus, according to various aspects of the invention, various approaches may be taken to provide improved precision in calculations associated with durations having undefined start datetimes. For example, a default start datetime may be assigned (e.g., 2007-04-01t00:00:00). In this example, a duration value of dur:2m would be evaluated as sixty-one days because April of 2007 has thirty days, while May of 2007 has thirty-one days. Selecting April 1st rather than January 1st as a default start datetime can provide an advantage of avoiding February early in a duration, thus providing better accuracy for durations of a few months, while also making dur:1m equal to thirty days, which may be more familiar to users accustomed to the XML duration schema.

In another example, a duration value expression may be parsed and analyzed to determine another datetime located within the expression, and an earliest datetime recited in the expression may be selected as the start datetime for every duration in the expression. Thus, an exemplary use of this technique may include an expression designed to evaluate how long a book was overdue from a library that lends books for three-month periods. The expression may take a form of (dateReturned−dateBorrowed)−dur:3m. This expression may be accurately evaluated, even when dur:3m does not have an associated start datetime, by identifying dateBorrowed as the earliest datetime recited in the expression (e.g., because a book must be borrowed before being returned). As such, dur:3m may be associated with a start datetime of dateBorrowed, enabling the expression to be accurately evaluated.

According to various aspects of the invention, an absolute value operator may be associated with the duration data type to provide duration-specific absolute value behavior. For example, the absolute value operator may be expressed as abs of, for example, as follows:

abs of dur:nynmndtnhnmns;yyyy-mm-ddthh:mm:ss±hh:mm

The absolute value operator may return unchanged operand values for non-negative durations, including the start datetime (when present). For a negative duration value having an undefined start datetime, the absolute value operator may simply return a non-negative value having equivalent duration components and an undefined start datetime. By contrast, for a negative duration having a defined start datetime may return, the absolute value operator may return an equivalent non-negative duration value, while adjusting the start datetime to account for timeline variations. As a result, the absolute value operator acting on a negative duration value returns an equivalent positive duration value, running over a uniform timeline range with respect to the negative duration value. For example, a duration of dur:−1y;2000-01-01 represents a negative duration of one year, which ends at Jan. 1, 2000. Thus, the absolute value of this duration would be dur:1y;01-01-1999, in that Jan. 1, 1999 would be a start date for a one year duration on a timeline ending Jan. 1, 2000. In another example, abs of dur:−1y1m1dt1h1m1s;2000-01-01 would be dur:1y1m1dt1h1m1s;1998-11-29t22:58:59. It will be appreciated that the provided examples should be regarded as exemplary only, as many other variations will be apparent.

It should be noted that in duration mathematics, an absolute value of a negative duration may not necessarily be equal in magnitude to a corresponding non-negative value (as would be the case for absolute value operations relating to integers). For example, the absolute value of dur:−1y;2000-01-01 would be dur:1y;1999-01-01, which includes a duration of three hundred and sixty-five days. By contrast, the absolute value of dur:1y;2000-01-01 would be dur:1y;2000-01-01, which includes a duration of three hundred and sixty-six days. Another distinction exists in that a negative duration may not necessarily be commutative with a negation of the duration. For example, while −dur:1y=dur:−1y, such equivalency may not exist when negative durations include an associated start datetime. For instance, a negation of a duration expression of −dur:1y;2000-01-01 would equal dur:−1y;2001-01-01, but would not equal dur:−1y;2000-01-01. For example, in this case, the negated duration contains three hundred and sixty-six days because the year 2000 was a leap year, yet the negative duration contains three hundred and sixty-five days because 1999 was not a leap year.

Thus, when performing duration calculations using a start datetime, it should be noted that a uniform timeline approach can result in certain operations varying somewhat with respect to conventional rules of mathematics. For example, when a duration includes a start datetime, a negation of the duration includes a start datetime that corresponds to an opposite endpoint on a timeline with respect to the start datetime in the duration being negated, with the duration running backwards in time along the timeline. For instance, as illustrated in FIG. 2c, a negative duration expression of dur:−1y;2000-01-01 includes a duration starting at Jan. 1, 2000 and going backwards in time for one year (i.e., “ending” at Jan. 1, 1999). By contrast, as illustrated in FIG. 2d, an absolute value of the negative duration yields the same one year period, but the start datetime would be Jan. 1, 1999 (i.e., the previous end datetime).

According to various aspects of the invention, a normalization operator may be used to rephrase a duration value into a form that maximizes components at each level. The duration may be normalized using an operator of durNormalize, for example, as follows:

durNormalize <duration expression> to <primary component>

The <primary component> aspect of the normalization operator may be taken from a set of {years, months, days, hours, minutes, seconds}. Thus, a duration value may be expressed in terms of a primary component (e.g., years, months, days, hours, minutes, or seconds) followed by less significant component values. For example, normalizing according to years as the primary component will result in no units being truncated, normalizing according to months will result in years being truncated, normalizing according to days will result in years and months being truncated, and so on. Thus, normalization results components having greater significance than the primary component being truncated.

As an example of normalization, a duration of one hundred hours, two hundred minutes, and three hundred and three seconds, which begins at Jan. 1, 2001 may typically be represented by dur:t100h200m303s;2001-01-01. The duration may be normalized for days by an expression of durNormalize dur:t100h200m303s;2001-01-01 to days, which would yield a normalized duration of dur:4dt7h25m3s;2001-01-01. Similarly, the duration can be normalized for hours by an expression of durNormalize dur:t100h200m303s;2001-01-01 to hours, which would yield a normalized duration of dur:t103h25m3s;2001-01-01.

Furthermore, in various implementations, the normalization operator may include an optional base datetime to be used for normalization, as follows:

durNormalize <duration expression> to <primary component> from <base datetime>

When normalizing a duration expression by specifying the optional base datetime, normalization may modify the duration expression. For example, normalizing a duration of expression dur:31d;2006-02-01 to months, without the optional base datetime, would yield a distinct result from normalizing the same expression to months with the optional base datetime (e.g., 2006-03-01). In particular, normalizing thirty-one days without specifying the base datetime would result in normalizing from Feb. 1, 2006 (i.e., dur:1m3d;2006-02-01), whereas normalizing from the base datetime of Mar. 1, 2006 would result in a distinct duration (i.e. dur:1m;2006-03-01). As a result, it will be apparent that normalization results may be dependent on whether the duration expression includes a start datetime and/or whether the normalization expression specifies the base datetime. In particular, when the duration expression does not include a start datetime, but the expression does include a base datetime, the base datetime can be associated with the duration expression, in addition being used for normalization. In another example, when the duration expression does not include a start datetime, and the base datetime has not been specified, normalization may use a default start datetime, which may also be associated with the duration expression. It will be apparent, however, that other variations may be supported without departing from the scope or spirit of the invention.

According to various aspects of the invention, a subtraction operator may be used to subtract a duration from a first datetime to yield a second datetime. Alternatively, the subtraction operator can be considered equivalent to adding a negated duration to the first datetime, which would also yield the second datetime. For example, given two datetimes, the subtraction operator may determine a duration of time associated with a segment of a timeline having opposing ends corresponding to the two date. Furthermore, the subtraction operator can determine which of the two datetimes occur earlier on the timeline, and the determined datetime may be association with the determined duration value. For example, using the subtraction operator, a duration value can be determined for a time period between datetimes of Jan. 1, 2000 and Jan. 1, 2001 using an expression of dtm:2000-01-01−dtm:2001-01-01, yielding dur:1y;2000-01-01.

According to various aspects of the invention, an addition operator can be used to add a datetime value and a duration value, thus yielding a second datetime value, which falls subsequently on a time line with respect to the datetime expression. For a non-negative duration value, the addition operator adds the duration value to the datetime value. By contrast, for a negative duration value, the addition operator subtracts the duration value from the datetime value. Furthermore, when the duration value does not include an associated start datetime, the duration value may be directly added/subtracted to/from the datetime value, without performing any normalization. However, when the duration value does include an associated start datetime, the duration value may first be normalized, using the duration value's associated start datetime as a base datetime. Subsequently, the normalized duration value may be added/subtracted to/from the datetime value. In various implementations, the duration value may be normalized to seconds (e.g., to increase precision), although it will be apparent that normalization to any of days, hours, minutes, or seconds can avoid indeterminacy problems associated with normalizing to years or months.

As an example, the addition operator may be used to add a duration value and a datetime value according to an expression such as dtm:2000-01-01+dur:1y;2000-01-02, yielding dtm:2001-01-01, whereas an expression of dtm:2000-01-01+dur:1y;2001-01-01 would yield dtm:2000-12-31. The yielded results differ in such a respect because in the second expression, the one-year duration value includes three hundred and sixty-five years, and the datetime value indicates a start datetime that begins in a three hundred and sixty-six day year (because the year 2000 was a leap year). By contrast, in the first expression, the one-year duration value includes three hundred and sixty-six days.

It will be apparent, however, that addition, subtraction, and other operators may operate in a generally similar manner. For example, when an arithmetic calculation for a duration expression includes a duration value having a start datetime, the duration value may be normalized according to days, hours, minutes, or seconds to improve precision of the calculation. When the duration value does not have a start datetime, however, components may simply be added and/or subtracted, with or without normalization. Furthermore, the foregoing descriptions provide exemplary descriptions of data types, operators, and techniques that can be used to accurately handle duration values using an associated start and/or end datetime. However, it will be apparent that the data types, operators, and techniques may be implemented in a variety of ways, and that the concepts described above can be applied in many other contexts, whether or not explicitly described. For example, to multiply and/or divide a duration value according to a number, the start datetime can be used to normalize the duration value (e.g., to seconds) prior to carrying out the multiplication or division on the normalized value, and the outcome of the operation can then be normalized back to desired units using the same datetime (e.g., to divide dur:1y;2000-01-01 by six, the duration may first be normalized to dur:31622400s;2000-01-01; then dividing by six would yield a duration expression of dur:5270400s;2000-01-01, which when normalized equals dur:2 m1d;2000-01-01). In another example, although the data types described above represent duration values using a similar manner of expression as defined by the XML schema, it will be appreciated that such representations have been used for simplicity purposes only, in that the XML schema representation may be familiar to use within systems that handle durations. Nonetheless, duration values may be represented using other formats or data structures, and start times may be associated with duration values using other forms of expression or other data formats, without limitation.

Furthermore, implementations of the invention may be made in hardware, firmware, software, or any suitable combination thereof. The invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described in the above disclosure in terms of specific exemplary aspects and implementations of the invention, and performing certain actions. However, it will be apparent that such descriptions are merely for convenience and that such actions in fact result from computing devices, processors, controllers, or other devices executing the firmware, software, routines, or instructions.

Aspects and implementations may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other aspects or implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A method for precisely handling a duration expression that references a duration of time, the duration of time having a temporal length dependent on one or more of a starting date or a starting time associated with the duration of time, comprising:
receiving a duration expression that includes a duration of time, the duration of time having a temporal length based on a datetime on which the duration of time begins or ends;
associating a start datetime with the duration of time, the associated start datetime representing an endpoint of a timeline segment defined by the duration of time, the endpoint of the timeline segment identifying the datetime on which the duration of time begins or ends; and
determining the temporal length of the duration of time based on the start datetime associated with the duration of time.

2. The method of claim 1, the received duration expression representing the duration of time according to one or more of a number of years, months, days, hours, minutes, or seconds.

3. The method of claim 1, wherein determining the temporal length of the duration of time includes adding the duration of time to the start datetime, wherein the adding yields an end datetime associated with the duration of time.

4. The method of claim 3, the start datetime and the end datetime defining opposite endpoints of the timeline segment having the temporal length corresponding to the duration of time.

5. The method of claim 1, the received duration expression further including the associated start datetime.

6. The method of claim 1, the associated start datetime including a default start datetime, wherein the associated start datetime includes the default start datetime when the received duration expression does not include a start datetime.

7. The method of claim 1, the duration of time including a negative duration of time, wherein the endpoint of the negative duration of time includes the datetime on which the duration of time ends.

8. The method of claim 7, wherein determining the temporal length of the duration of time includes determining an absolute value of the negative duration of time, the determined absolute value including a non-negative duration of time having a temporal length equal to the temporal length of the duration of time, the determined absolute value further including a datetime representing a datetime on which the non-negative duration of time begins.

9. The method of claim 1, wherein determining the temporal length of the duration of includes normalizing the duration of time, the normalizing defining the duration of time according to a primary duration component.

10. The method of claim 9, the primary duration component including one or more of years, months, days, hours, minutes, or seconds, the normalized duration of time truncating components of the duration of time having greater significance than the primary duration component.

11. A computer readable medium storing computer executable instructions for precisely handling a duration expression that references a duration of time, the duration of time having a temporal length dependent on one or more of a starting date or a starting time associated with the duration of time, the instructions operable when executed to:
receive a duration expression that includes a duration of time, the duration of time having a temporal length based on a datetime on which the duration of time begins or ends;
associate a start datetime with the duration of time, the associated start datetime representing an endpoint of a timeline segment defined by the duration of time, the endpoint of the timeline segment identifying the datetime on which the duration of time begins or ends; and
determine the temporal length of the duration of time based on the start datetime associated with the duration of time.

12. The computer readable medium of claim 11, the received duration expression representing the duration of time according to one or more of a number of years, months, days, hours, minutes, or seconds.

13. The computer readable medium of claim 11, the instructions operable to determine the temporal length of the duration of time by adding the duration of time to the start datetime, wherein the adding yields an end datetime associated with the duration of time.

14. The computer readable medium of claim 13, the start datetime and the end datetime defining opposite endpoints of the timeline segment having the temporal length corresponding to the duration of time.

15. The computer readable medium of claim 11, the received duration expression further including the associated start datetime.

16. The computer readable medium of claim 11, the associated start datetime including a default start datetime, wherein the associated start datetime includes the default start datetime when the received duration expression does not include a start datetime.

17. The computer readable medium of claim 11, the duration of time including a negative duration of time, wherein the endpoint of the negative duration of time includes the datetime on which the duration of time ends.

18. The computer readable medium of claim 17, the instructions operable to determine the temporal length of the duration of time by determining an absolute value of the negative duration of time, the determined absolute value including a non-negative duration of time having a temporal length equal to the temporal length of the duration of time, the determined absolute value further including a datetime representing a datetime on which the non-negative duration of time begins.

19. The computer readable medium of claim 11, the instructions operable to determine the temporal length of the duration of by normalizing the duration of time, the normalizing defining the duration of time according to a primary duration component.

20. The computer readable medium of claim 19, the primary duration component including one or more of years, months, days, hours, minutes, or seconds, the normalized duration of time truncating components of the duration of time having greater significance than the primary duration component.

21. A system for precisely handling a duration expression that references a duration of time, the duration of time having a temporal length dependent on one or more of a starting date or a starting time associated with the duration of time, the system comprising one or more processing devices collectively operable to:
receive a duration expression that includes a duration of time, the duration of time having a temporal length based on a datetime on which the duration of time begins or ends;
associate a start datetime with the duration of time, the associated start datetime representing an endpoint of a timeline segment defined by the duration of time, the endpoint of the timeline segment identifying the datetime on which the duration of time begins or ends; and
determine the temporal length of the duration of time based on the start datetime associated with the duration of time.

22. The system of claim 21, the received duration expression representing the duration of time according to one or more of a number of years, months, days, hours, minutes, or seconds.

23. The system of claim 11, the processing devices operable to determine the temporal length of the duration of time by adding the duration of time to the start datetime, wherein the adding yields an end datetime associated with the duration of time.

24. The system of claim 23, the start datetime and the end datetime defining opposite endpoints of the timeline segment having the temporal length corresponding to the duration of time.

25. The system of claim 21, the received duration expression further including the associated start datetime.

26. The system of claim 21, the associated start datetime including a default start datetime, wherein the associated start datetime includes the default start datetime when the received duration expression does not include a start datetime.

27. The system of claim 21, the duration of time including a negative duration of time, wherein the endpoint of the negative duration of time includes the datetime on which the duration of time ends.

28. The system of claim 27, the processing devices operable to determine the temporal length of the duration of time by determining an absolute value of the negative duration of time, the determined absolute value including a non-negative duration of time having a temporal length equal to the temporal length of the duration of time, the determined absolute value further including a datetime representing a datetime on which the non-negative duration of time begins.

29. The system of claim 11, the processing devices operable to determine the temporal length of the duration of by normalizing the duration of time, the normalizing defining the duration of time according to a primary duration component.

30. The system of claim 29, the primary duration component including one or more of years, months, days, hours, minutes, or seconds, the normalized duration of time truncating components of the duration of time having greater significance than the primary duration component.
